(19) United States
(12) Patent Application Publication
(10) Pub. No.: US 2008/0176079 A1
(43) Pub. Date: Jul. 24, 2008

(54) Process for coating vehicle exterior parts made from thermoplastic composite articles

(76) Inventors: Andri E. Elia, Chadds Ford, PA (US); Toshikazu Kobayashi, Chadds Ford, PA (US); William Daniel Saunders, Delaware City, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/999,138

(22) Filed: Dec. 4, 2007

Related U.S. Application Data
(60) Provisional application No. 60/875,772, filed on Dec. 19, 2006.

(51) Int. Cl. B32B 7/02; B05D 3/00; C25D 5/48

(52) U.S. Cl. 428/411.1; 427/331; 427/333; 205/198

(57) ABSTRACT

A process for coating vehicle parts comprising composite articles having good mechanical properties and smooth surface appearance comprising a reinforced thermoplastic polymeric component and a film.

### CROSS REFERENCE TO RELATED APPLICATIONS

This application claims the benefit of U.S. Provisional Application No. 60/875,772, filed Dec. 19, 2006.

### FIELD OF THE INVENTION

The present invention relates to a process for coating vehicle parts comprising composite articles having good mechanical properties and smooth surface appearance comprising a reinforced thermoplastic polymeric component and a film.

### BACKGROUND OF THE INVENTION

The bodies of automobiles and other vehicles, including trucks, motorcycles, recreational vehicles, farm equipment, etc. have traditionally been made from sheet metal. Metal parts can be manufactured to have smooth, glossy surfaces that are desirable for automobiles and other vehicles. The good temperature resistance of metal body parts allows them to be conveniently coated using an online coating process. In an online coating process, metal body parts are attached to the chassis of the vehicle and given a first coating that serves in part to provide corrosion-resistance treatment through electrodeposition of a primer, the so-called “E-coat.” The exterior of the vehicle is then treated with additional coating layers that can include a primer surfacer coat, a base coat containing the desired colorants, and a clear coat. During these coating steps, the vehicle body can in some cases be exposed to oven temperatures in excess of 200° C. for as long as at least 30 minutes. In particular, the E-coat can require extended exposure to high temperatures while curing.

It would be desirable to make vehicle exterior parts from polymeric materials because of their light weight relative to metal and the ease with which they can be molded into parts with intricate and complicated shapes. However, the polymeric materials must be able to be molded into articles that, when coated, have very similar or identical color tone, gloss, and short- and long-wave values to coated metal parts on the vehicle. The molded polymeric articles must also have good impact resistance, rigidity, chemical resistance, and dimensional stability as well as a surface appearance that meets the demanding requirements of vehicle exterior parts.

In an offline coating process, the polymeric parts are coated separately from the rest of the vehicle body and attached after the rest of the body is coated in an online process. This means that the polymeric parts do not need to be exposed to the high temperatures of the online coating process. Disadvantages of this process include that it increases expense and that exact color matching between polymeric and metal parts can be difficult to achieve.

In an inline coating process only metal exterior parts are subjected to the electrodeposition primer coating process and its possible high temperature drying step. Polymeric parts are then added to the body of the vehicle for subsequent coating steps. This, however, requires additional steps in and interruption of the coating process that can introduce dust and other impurities into the process.

Furthermore, coating steps such as the application of the primer/surfacer coat are often done by electrostatic spraying, which requires that the part being coated be electrically conductive. Most polymeric materials are electrically insulative, and thus, polymeric parts that are to be online coated must first be treated with a conductive primer before the application of the primer/surfacer coat, adding further complexity and expense to the process.

Thus, it would be desirable to make polymeric exterior parts that could be attached to the vehicle body prior to the E-coat step and be coated together with any metal parts present using standard online coating processes. This requires the use of polymer compositions that can withstand the conditions used for the E-coat step and subsequent coating steps without heat distortion and deformation. However, thermoplastic compositions often possess an insufficient combination of stiffness, strength, toughness, and/or other physical properties to satisfy the requirements of many of these applications. Additives such as reinforcing agents, fillers, and impact modifiers may be used to improve the physical properties of the compositions, but the addition of such of additives often results in a finished part having a poorer surface appearance. In some cases, the coating process may yield an adequate surface appearance and impart desired color and other properties, but in many cases, the poor surface appearance caused by many additives effective to improve properties cannot be sufficiently improved by coating the surface.

It would be thus be desirable to obtain coated polymeric vehicle parts having good mechanical properties and an good surface appearance.

The article Brosius, Dale, “In-Mold Decorating Dresses up Composites,” Composites Technology August 2005, discloses parts made by molding long fiber-reinforced thermoplastics (such as ABS and ABS blends and polyolefins) over preformed decorative films.

### SUMMARY OF THE INVENTION

There is disclosed and claimed herein A process for coating a vehicle exterior part with visible polymeric surfaces, comprising the successive steps of applying and curing at least one coating on the visible surfaces of the substrate, wherein the part comprises a composite article, comprising,
(a) a molded part having a surface and comprising a thermoplastic polymeric composition comprising at least one thermoplastic polymer and at least one reinforcing agent, and
(b) a thermoplastic polymeric film having first and second surfaces opposite to each other,
   wherein the surface of the first component (a) is adhered to the first surface of the film (b) and wherein the second surface of film (b) forms a part or all of the visible polymeric surfaces; and wherein the thermoplastic polymeric composition has a tensile modulus of least about 11 GPa, as measured by ISO method 527-2:1993 at a rate of 5 mm/min on test specimens having a thickness of 4 mm; and a notched Charpy impact strength of at least about 35 kJ/m², as measured by ISO method 179-1:2000.

### DETAILED DESCRIPTION OF THE INVENTION

The process of the present invention provides for the coating of a vehicle exterior part that comprises a composite article. The composite article comprises a first component comprising a molded part comprising a thermoplastic polymeric composition and a thermoplastic polymeric film adhered to the first component. In the process, the coating is applied to all or part of the surface of the thermoplastic film.

The vehicle parts may be coated using an online process or an offline or inline process. Examples of vehicles include automobiles, trucks, vans, motorcycles, bicycles, all-terrain vehicles, aquatic vehicles including boats and ships, snowmobiles, lawnmowers, tractors and other farm equipment, aircraft, bulldozers and other construction equipment, and the like. Examples of exterior parts include fenders, hoods, trunk doors, lift-up tailgates, doors, side panels, protective moldings, spoilers, hub caps, body sills, door sills, door handles, radiator grilles, tank flaps, bumpers, mirror housings, and other exterior parts.

The thermoplastic polymeric composition may comprise one or more thermoplastics. Examples of suitable thermoplastic polymers include, but are not limited to, polyamides, polyesters (including aromatic polyester and aliphatic polyester), liquid crystalline polyesters (LCP), poly(lactic acid) (including d,l-complexed poly(lactic acid)), polyolefins (such as polyethylene and polypropylene), polycarbonates, acrylonitrile-butadiene-styrene polymers (ABS), poly(phenylene oxide)s (PPO), poly(phenylene sulfide)s, polysulphones, polyarylates, polyetheretherketones (PEEK), polyetherketoneketones (PEKK), polyacetals, polystyrenes, and syndiotactic polystyrenes. Thermoplastic alloys, such as polyamide/poly(phenylene oxide) alloys, polyester/ABS alloys (including poly(butylene terephthalate)/ABS alloys)); polyester/polycarbonate alloys (including poly(butylene terephthalate)/polycarbonate alloys)); and polyester/poly(lactic acid) alloys (including poly(1,3-propylene terephthalate)/poly(lactic acid) alloys)) may be used.

When the coating process involves an E-coat step, the thermoplastics preferably have melting points of at least about 200° C. If an E-coat step is not used, the thermoplastics preferably have melting points of at least about 160° C.

Suitable polyamides can be condensation products of one or more dicarboxylic acids and one or more diamines, and/or one or more aminocarboxylic acids, and/or ring-opening polymerization products of one or more cyclic lactams. Polyamides may include aliphatic, aromatic, and/or semi-aromatic polyamides.

Suitable dicarboxylic acids include, but are not limited to, adipic acid, azelaic acid, terephthalic acid (abbreviated as “T” in polyamide designations), and isophthalic acid (abbreviated as “I” in polyamide designations). Preferred are dicarboxylic acids having 10 or more carbon atoms, including, but not limited to sebacic acid; dodecanedioic acid, tetradecanedioic acid, pentadecanedioic acid, and the like.

Suitable diamines include, but are not limited to, tetramethylenediamine; hexamethylenediamine; octamethylenediamine; nonamethylenediamine; 2-methylpentamethylenediamine; 2-methyloctamethylenediamine; trimethylhexamethylenediamine; bis(p-aminocyclohexyl)methane; m-xylylenediamine; and p-xylylenediamine. Preferred diamines have 10 or more carbon atoms, including, but not limited to decamethylenediamine; undecamethylenediamine; dodecamethylenediamine; tridecamethylenediamine; tetramethylenediamine; pentamethylenediamine; hexamethylenediamine; and the like.

A suitable aminocarboxylic acid is 1-aminododecanoic acid. Suitable cyclic lactams are caprolactam and laurolactam.

Preferred polyamides include aliphatic polyamides such as polyamide 6; polyamide 6,6; polyamide 4,6; polyamide 6,10; polyamide 6,12; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14; polyamide 6,14; polyamide 6,13; polyamide 6,15; polyamide 6,16; polyamide 6,13; and semi-aromatic polyamides such as poly(m-xylylene adipamide) (polyamide MXD,6) and polyterethalamides such as poly(dodecamethylene terephthalamide) (polyamide 12,T), poly(decamethylene terephthalamide) (polyamide 10,T), poly(nonamethylene terephthalamide) (polyamide 9,T), hexamethylene adipamide/hexamethylene terephthalamide copolyamide (polyamide 6,T/6,6), hexamethylene terephthalamide/2-methylpentamethylene terephthalamide copolyamide (polyamide 6,T/D,T); hexamethylene adipamide/hexamethylene terephthalamide/hexamethylene isophthalamide copolyamide (polyamide 6,6/6,T/6,I); poly(caprolactam-hexamethylene terephthalamide) (polyamide 6/6,T); and copolymers and mixtures of these polymers.

Preferred thermoplastic polyesters (which have mostly, or all, ester linking groups) are normally derived from one or more dicarboxylic acids (or their derivatives such as esters) and one or more diols. In preferred polyesters the dicarboxylic acids comprise one or more of terephthalic acid, isophthalic acid, and 2,6-naphthalene dicarboxylic acid, and the diol component comprises one or more of HO(CH₂)ₙOH (I), 1,4-cyclohexanedimethanol, HO(CH₂CH₂O)ₘCH₂CH₂OH (II), and HO(CH₂CH₂CH₂CH₂O)_{z}CH₂CH₂CH₂CH₂OH (III), wherein n is an integer of 2 to 10, m on average is 1 to 4, and z is on average about 7 to about 40. Note that (II) and (III) may be a mixture of compounds in which m and z, respectively, may vary and that since m and z are averages, they do not have to be integers. Other diacids that may be used to form the thermoplastic polyester include sebacic and adipic acids. Hydroxycarboxylic acids such as hydroxybenzoic acid may be used as comonomers. Specific preferred polyesters include poly(ethylene terephthalate) (PET), poly(1,3-propylene terephthalate) (PPT), poly(1,4-butylene terephthalate) (PBT), poly(ethylene naphthalate) (PEN), and poly(1,4-cyclohexyldimethylene terephthalate) (PCT),

By a “liquid crystalline polymer” (abbreviated “LCP”) is meant a polymer that is anisotropic when tested using the TOT test or any reasonable variation thereof, as described in U.S. Pat. No. 4,118,372, which is hereby included by reference. Useful LCP's include polyesters, poly(ester-amides), and poly(ester-imides). One preferred form of LCP is “all aromatic”, that is all of the groups in the polymer main chain are aromatic (except for the linking groups such as ester groups), but side groups that are not aromatic may be present.

LCP's are typically derived from monomers that include aromatic hydroxycarboxylic acids, aromatic dicarboxylic acids, aliphatic dicarboxylic acids, aromatic diols, aliphatic diols, aromatic hydroxyamines, and aromatic diamines. For example, they may be aromatic polyesters that are obtained by polymerizing one or two or more aromatic hydroxycarboxylic acids; aromatic polyesters obtained by polymerizing aromatic dicarboxylic acids, one or two or more aliphatic dicarboxylic acids, aromatic diols, and one or two or more aliphatic diols, or aromatic hydroxycarboxylic acids; aromatic polyesters obtained by polymerizing one or two or more monomers selected from a group including aromatic dicarboxylic acids, aliphatic dicarboxylic acids, aromatic diols, and aliphatic diols, aromatic polyester amides obtained by polymerizing aromatic hydroxyamines, one or two or more aromatic diamines, and one or two or more aromatic hydroxycarboxylic acids; aromatic polyester amides obtained by polymerizing aromatic hydroxyamines, one or two or more aromatic diamines, one or two or more aromatic hydroxycarboxylic acids, aromatic dicarboxylic acids, and one or two or more aliphatic carboxylic acids; and aromatic polyester amides obtained by polymerizing aromatic hydroxyamines, one or two or more aromatic diamines, one or two or more aromatic hydroxycarboxylic acids, aromatic dicarboxylic acids, one or two or more aliphatic carboxylic acids, aromatic diols, and one or two or more aliphatic diols.

Examples of aromatic hydroxycarboxylic acids include 4-hydroxybenzoic acid, 3-hydroxybenzoic acid, 2-hydroxybenzoic acid, 6-hydroxy-2-naphthoic acid, and halogen-, alkyl-, or allyl-substituted derivatives of hydroxybenzoic acid.

Examples of aromatic dicarboxylic acids include terephthalic acid; isophthalic acid; 3,3′-diphenyl dicarboxylic acid; 4,4′-diphenyl dicarboxylic acid; 1,4-naphthalene dicarboxylic acid; 1,5-naphthalene dicarboxylic acid; 2,6-naphthalene dicarboxylic acid; and alkyl- or halogen-substituted aromatic dicarboxylic acids, such as t-butylterephthalic acid, chloroterephthalic acid, etc.

Examples of aliphatic dicarboxylic acids include cyclic aliphatic dicarboxylic acids; such as trans-1,4-cyclohexane dicarboxylic acid; cis-1,4-cyclohexane dicarboxylic acid; 1,3-cyclohexane dicarboxylic acid; and substituted derivatives thereof.

Examples of aromatic diols include hydroquinone; biphenol; 4,4′-dihydroxydiphenyl ether; 3,4′-dihydroxydiphenyl ether; bisphenol A; 3,4′-dihydroxydiphenylmethane; 3,3′-dihydroxydiphenylmethane; 4,4′-dihydroxydiphenylsulfone; 3,4′-dihydroxydiphenylsulfone; 4,4′-dihydroxydiphenylsulfide; 3,4′-dihydroxdiphenylsulfide; 2,6′-naphthalenediol; 1,6′-naphthalenediol; 4,4′-dihydroxybenzophenone; 3,4′-dihydroxybenzophenone; 3,3′-dihydroxybenzophenone; 4,4′-dihydroxydiphenyldimethylsilane; and alkyl- and halogen-substituted derivatives thereof.

Examples of aliphatic diols include cyclic, linear, and branched aliphatic diols, such as trans-1,4-hexanediol; cis-1,4-hexanediol; trans-1,3-cyclohexanediol; cis-1,2-cyclohexanediol; ethylene glycol; 1,4-butanediol; 1,6-hexanediol; 1,8-octanediol; trans-1,4-cyclohexanedimethanol; cis-1,4-cyclohexanedimethanol; etc., and substituted derivatives thereof.

Examples of aromatic hydroxyamines and aromatic diamines include 4-aminophenol, 3-aminophenol, p-phenylenediamine, m-phenylenediamine, and substituted derivatives thereof.

Poly(lactic acid) (PLA) includes poly(lactic acid) homopolymers and copolymers of lactic acid and other monomers containing at least 50 mole % of repeat units derived from lactic acid or its derivatives and mixtures thereof having a number average molecular weight of 3,000 to 1,000,000, 10,000 to 700,000, or 20,000 to 600,000. The poly(lactic acid) may contain at least 70 mole % of repeat units derived from (e.g. made by) lactic acid or its derivatives. The poly(lactic acid) homopolymers and copolymers can be derived from d-lactic acid, l-lactic acid, or a mixture thereof. A mixture of two or more poly(lactic acid) polymers can be used. Poly(lactic acid) may be prepared by the catalyzed ring-opening polymerization of the dimeric cyclic ester of lactic acid, which is referred to as “lactide.” As a result, poly(lactic acid) is also referred to as “polylactide.” Copolymers of lactic acid are typically prepared by catalyzed copolymerization of lactic acid, lactide or another lactic acid derivative with one or more cyclic esters and/or dimeric cyclic esters.

The thermoplastic polymer is present in the composition in about 20 to about 60 weight percent, or preferably in about 30 to about 50 weight percent, or more preferably in about 30 to about 40 weight percent, based on the total weight of the composition.

The compositions comprise at least one reinforcing agent. Suitable reinforcing agents include fibrous reinforcing agents such as glass fibers, carbon fibers, and mineral fibers such as wollastonite. Preferred are long fibers, such as glass or carbon fibers that have a number average length of about 2 to about 7 mm after the composition has been formed into the first component. The composition may contain reinforcing agents and fillers in platy, granular, beadlike, and other forms, such as talc, mica, kaolin, glass beads, glass flakes, and the like. The composition may contain nanoparticulate reinforcing agents and fillers such as carbon nanotubes and nanoclays, including montmorillonite and sepiolite.

The reinforcing agent is present in the composition in about 40 to about 80 weight percent, or preferably in about 50 to about 70 weight percent, or more preferably in about 60 to about 70 weight percent, based on the total weight of the composition. The compositions may comprise electrically conductive additives such as carbon black, carbon fibers, metal-coated carbon fibers, carbon nanotubes, and ion conductive polymeric systems, such as those comprising ion conductive polymers and ion sources. Ion conductive polymers include polyetheresteramides and polyesteramide block copolymers. Ion sources include sodium, potassium, and lithium salts. The ion source is preferably present in at least about 200 ppm or more preferably in at least about 1000 ppm, relative to the ion conductive polymer.

The composition may contain additional components such as flame retardants, flame retardant synergists, impact modifiers, stabilizers (such as oxidation, heat, ultraviolet light, etc. stabilizers), colorants (including pigments, dyes, and carbon black), plasticizers, thermally conductive additives, lubricants, nucleating agents, and the like.

The composition used in the present invention is made by melt-blending the components using any known methods. The component materials may be mixed to uniformity using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed until uniform.

The composition has a tensile modulus of at least about 11 GPa, or preferably of at least about 13 GPa, or more preferably of at least about 14 GPa, or yet more preferably of at least about 17 GPa. Tensile modulus is measured according to ISO method 527-2:1993 at a rate of 5 mm/min on test specimens having a thickness of 4 mm.

The composition has a notched Charpy impact strength of at least about 35 kJ/m², or preferably of at least about 40 kJ/m², or more preferably of at least about 50 kJ/m², or yet more preferably of at least about 60 kJ/m², Notched Charpy impact strength is measured according to ISO method 179-1:2000 using a hammer size between 2.0 and 7.5 Joules, inclusive.

The composition preferably has a coefficient of thermal linear expansion of less than or equal to about 50×10⁻⁶/K at 20° C., or more preferably of less than or equal to about 40×10⁻⁶/K at 20° C., or yet more preferably of less than or equal to about 30×10⁻⁶/K at 20° C., or still more preferably of less than or equal to about 20×10⁻⁶/K at 20° C.

The thermoplastic polymeric film may have a single layer or comprise two or more layers, where the two or more layers may be the same or different materials. Where two or more layers are used, one layer may be selected to serve as a tie layer to enhance adhesion of the film to the surface of the first component. As will be understood by those skilled in the art, the composition of the film may be selected to optimize adhesion to the composition of the first component.

The films typically have a thickness of about 8 to about 20 mil. The films are preferably unfilled or filled with nanoparticulate fillers such as nanoclays or electrically conductive fillers, provided that any fillers used do not detract from the surface appearance of the resulting composite article. Examples of electrically conductive fillers include electroconductive or electrostatically dissipative carbon blacks and ion conductive polymers with one or more ion sources.

The nanoclays may be layered silicates, and preferably aluminum and/or magnesium silicates. The nanoclays may be in the form of fibrils, platelets, or other shapes and have a diameter in the range of about 10 to about 5000 nm. The layer thickness is less than about 2 nm. The nanoclays will preferably be swellable clays, meaning that the clays have the ability to absorb water or other polar organic liquids such as methanol and ethanol between the layers. When the liquids are absorbed, the nanoclays swell. At least one dimension of the nanoclay particles will be less than about 20 nm, and preferably less than about 5 nm. The nanoclays contain interlayer cations such as alkali and alkaline earth metal cations. Preferred cations include sodium and calcium ions. The nanoclays are used in an untreated form, meaning that they are not treated with an agent, such as a surfactant, to exchange metal cations present between the layers with organic cations such as ammonium or other onium ions.

Preferred nanoclays are fibrils having number average diameters less than or equal to about 70 nanometers and number average lengths of up to about 1000 nanometers. Examples of preferred nanoclays include sepiolite and smectite clays such as montmorillonite, hectorite, saponite, beidelllite, nontronite, bentonite, saponite, and the like. Both natural and synthetic nanoclays may be used. Natural nanoclay such as Cloisite® Na+ and synthetic smectite clays such as Laponite® are available from Southern Clay Products.

Electroconductive carbon blacks may include electroconductive furnace blacks. It is preferable that the electroconductive carbon black have a specific surface area of at least about 700 m²/g and an oil absorption of from 2 to 4 mL/g. Suitable electroconductive carbon blacks include Ketjenblack® products supplied by Akzo Nobel.

Preferred films comprise polyesters such as poly(ethylene terephthalate) and polyamides, including polyterephthalamides such as hexamethylene adipamide/hexamethylene terephthalamide copolyamide (polyamide 6,T/6,6) and hexamethylene terephthalamide/2-methylpentamethylene terephthalamide copolyamide (polyamide 6,T/D,T).

When the coating process involves an E-coat step, the polymers comprising the film preferably have melting points of at least about 200° C. If an E-coat step is not used, the polymers comprising the film preferably have melting points of at least about 160° C.

Examples of suitable components for use as a tie layer include, but are not limited to, ethylene/vinyl alcohol copolymers, ethylene/vinyl acetate copolymers, ethylene/vinyl alcohol/vinyl acetate copolymers, and ionomeric polymers. The ionomeric polymers preferably comprise about 90 to 99 mole percent of repeat units derived from olefins and about 1 to 10 mole percent of repeat units derived from α,β-ethylenically unsaturated monomers having carboxylic moieties wherein the moieties are considered as acid equivalents and are neutralized with metal ions having valences of 1 to 3, inclusive, where the carboxylic acid equivalent is monocarboxylic and are neutralized with metal ions having a valence of 1 where the carboxylic acid equivalent is dicarboxylic. To control the degree of neutralization, metal ions are present in an amount sufficient to neutralize at least 10 percent of the carboxyl moieties. Ionomeric polymers are described in greater detail in U.S. Pat. No. 3,264,272. Ionomeric polymers are supplied under the tradename Surlyn® by E.I. du Pont de Nemours and Co., Wilmington, Del.

Fillers may be added to the polymeric materials comprising the film by any suitable melt-blending method, such as extrusion. The films may be formed using any suitable method known in the art.

The composite articles are preferably formed by molding the composition of the of the first component into the form of a part onto a surface of the film. The film may be used flat, curved, bent, or in any other suitable preformed shape. The film may be preformed into a shape by any method known in the art, including thermoforming.

Such molding may be done by placing the film into a mold and overmolding the composition of the component onto the surface of the film, Suitable molding methods include, but are not limited to, injection molding, compression-injection molding, and compression molding. The composite articles may also be made coextruding the film and the composition of the first component. All or part of the surface of the composite article may comprise the film.

In one embodiment of the present invention, the composite article will be electrically conductive. By “electrically conductive” is meant that vehicle body parts made from the composition may be electrostatically coated using methods known to those skilled in the art without the addition of a conductive primer. Electrical conductively can be imparted by the addition of electrically conductive additives to the thermoplastic polymeric composition and/or the film.

That the composite article is electrically conductive can be determined by measuring the decay of electrostatic charge accumulated on the surface of the article. Articles having rapid charge decay times are suitable for use in electrostatic coating processes. The decay times may, for example, be determined by electrostatically charging parts made from the compositions to a surface potential of about 6000 V and measuring the surface charge 30 seconds after removal of the electrostatic field. Parts having a residual surface potential of below about 500 V are deemed to contain sufficient conductive filler to allow them to be used in an electrostatic coating process without the addition of a conductive primer.

The composite article may be formed into a vehicle exterior part when the composite article is itself formed, such as by overmolding the composition of the first component onto a surface of the film. Alternatively, the composite article may be formed into a vehicle exterior part by forming the existing composite article into the shape of a vehicle exterior part using a method such as thermoforming or machining or other methods known to those skilled in the art.

While painting, the paint is applied to the vehicle exterior part on all or a portion of surface of the film opposite the surface that is adhered to the first component. The paint may also be applied to portions of the surface of the part that do not comprise a film component.

The vehicle exterior parts may optionally be coated with a conductive primer that provides the parts with sufficient electrical conductivity for electrostatically-assisted coating processes, as will be understood by one skilled in the art. The parts may be attached to the frame of the vehicle, optionally in the presence of other exterior parts made from any appropriate materials, including metals such as galvanized and ungalvanized steel, aluminum and aluminum alloys, and magnesium and magnesium alloys. In one embodiment of the invention that may be part of an offline or inline coating process, at least one part comprising the polyamide compositions used in the present invention, optionally attached to a vehicle frame, is treated with at least one coating layer, preferably applied by a spraying process, and more preferably applied by an electrostatically-assisted spraying process to at least the visible surfaces of the exterior parts. Examples of conventional multicoat constructions formed from a plurality of coating layers include primer surfacer/top coat; primer surfacer/base coat/clear coat; base coat/clear coat; and primer surfacer substitute layer/base coat/clear coat.

Primer surfacer or primer surfacer substitute coatings are designed to smooth the surface of the parts and remove imperfections and provide stone-chip protection. They also prepare the surface for subsequent decorative and protective top coatings. The base coat typically contains colorants such as pigments and provides protection against the elements. The multicoat constructions may be further coated over part or all of the surface with a transparent sealing coat that may provide high scratch resistance.

The coating layers may be applied using conventional coating agents known to those skilled in the art. The coating agents may be powder coating agents or liquid coating agents containing, e.g., water and/or organic solvents as diluents. The coating agents may be single- or multi-component coating agents. They may be dried physically or by oxidation or by using chemical cross-linking agents. Primer surfacers top coats, clear coats, and sealing coats are preferably chemically cross-linked using systems that can be cured thermally (e.g. by convection and/or infrared radiation) and/or by radiation, such as ultraviolet radiation.

If more than one coating layer is applied, each coating layers does not have to be cured separately prior to the application of the subsequent layer. As will be understood by one skilled in the art, coating layers may be applied to wet layers and two or more layers may be cured together. For example, in the case of a base coat and a clear coat, following the application of the base coat, and optionally a short flash-off phase, the clear coat may be applied and cured together with the base coat.

In another embodiment of the process of the present invention that may be part of an online coating process, prior to the application of one or more additional coating layers as described above, at least one vehicle exterior part comprising the polyamide compositions used in the present invention and at least one metal vehicle exterior part, where the parts are optionally attached to a vehicle frame, is treated with a corrosion-resistance electrodeposition primer coating (referred to as an “E-coat”) in a conventional electrodeposition process that is known to one skilled in the art. Suitable coating agents include waterborne compositions with a solids content of about 10 to about 30 weight percent.

Suitable coating agents may be anodic electrodeposition compositions known to those skilled in the art. The binders used in anodic coating compositions can include, but are not limited to polyesters, epoxy resin esters, (meth)acrylic copolymer resins, maleinate oils or polybutadiene oils with a weight average molecular weight of about 300 to about 10,000 and a carboxyl group content corresponding to an acid value of about 35 to about 300 mg KOH/g. At least a portion of the carboxyl groups are preferably converted carboxylate groups by neutralization with base. The binders may be self-cross-linking or may be cross-linked with separate cross-linking agents.

Suitable coating agents may also be cathodic electrodeposition compositions. Preferred cathodic electrodeposition compositions contain binders with cationic groups or groups that can be converted to cationic groups, such as basic groups. Examples of suitable groups can include amino; ammonium, such as quaternary ammonium; phosphonium; and/or sulfonium groups. Nitrogen-containing basic groups are preferred and may be present in a quaternized form or converted to cationic groups with a conventional neutralizing agent such as an organic monocarboxylic acid such as formic acid, lactic acid, methane sulfonic acid or acetic acid. Preferred are basic resins with primary, secondary, and/or tertiary amino groups corresponding to an amine value of about 20 to about 200 mg KOH/g. The weight average molecular weight of the binders is preferably about 300 to about 10,000. Examples of suitable binders include amino(meth)acrylic resins, aminoepoxy resins, aminoepoxy resins with terminal double bonds, aminoepoxy resins with primary hydroxyl groups, aminopolyurethane resins, amino group containing polybutadiene resins, or modified epoxy resin/carbon dioxide-amine reaction products. The binders may be self-cross-linking or may be cross-linked with separate cross-linking agents present in the mixture. Examples of suitable cross-linking agents include aminoplastic resins, blocked polyisocyanates, cross-linking agents with terminal double bonds, polyepoxy compounds, or cross-linking agents containing groups capable of transesterification.

The electrodeposition coating compositions may further contain pigments, fillers, and/or conventional coating additives. Examples of suitable pigments include conventional inorganic and/or organic colored pigments and/or fillers such as carbon black, titanium dioxide, iron oxide pigments, phthalocyanine pigments, quinacridone pigments, kaolin, talc or silicon dioxide. Examples of additives include wetting agents, neutralizing agents, leveling agents, catalysts, corrosion inhibitors, anti-cratering agents, anti-foaming agents, and solvents.

An electrodeposition coating process known to those skilled in the art may be used. Deposition voltages may be about 200 to about 500 V. After deposition of the coating, the substrate may be cleaned of any excess or adhering but non-deposited coating in a manner known to those skilled in the art, by, for example, rinsing with water. The coated vehicle exterior parts are then baked at oven temperatures of up to about 200 to about 220° C. in order to cross-link the electrodeposition coating.

The surface smoothness of the portion of the surface of the composite article comprising the coated film may be evaluated using wave scan testing using a BYK-Gardner wave scan DOI instrument. Wave scan testing measures a surface profile of painted surfaces using wavelengths of 0.1-0.3 mm (Wa); 0.3-1 mm (Wb), 1-3 mm (Wc), 3-10 mm (Wd); and 10-30 mm (We). Wb is used to evaluate the telegraphing of a substrate surface profile through paint films. A Wb of less than 30 indicates that a paint film sufficiently hides the substrate profile and provides a class A surface appearance. The surface of the coated film preferably has a Wb value of less than or equal to about 40, or more preferably of less than or equal to about 30, or yet more preferably of less than or equal to about 20, or still more preferably of less than or equal to about 10.

What is claimed is:

1. A process for coating a vehicle exterior part with visible polymeric surfaces, comprising the successive steps of applying and curing at least one coating on the visible surfaces of the substrate, wherein the part comprises a composite article, comprising,
(a) a molded part having a surface and comprising a thermoplastic polymeric composition comprising at least one thermoplastic polymer and at least one reinforcing agent, and
(b) a thermoplastic polymeric film having first and second surfaces opposite to each other,
wherein the surface of the first component (a) is adhered to the first surface of the film (b) and wherein the second surface of film (b) forms a part or all of the visible polymeric surfaces; and wherein the thermoplastic polymeric composition has a tensile modulus of least about 11 GPa, as measured by ISO method 527-2:1993 at a rate of 5 mm/min on test specimens having a thickness of 4 mm; and a notched Charpy impact strength of at least about 35 kJ/m², as measured by ISO method 179-1:2000.

2. The process of claim 1, wherein the thermoplastic polymer comprises at least one polyamide and/or least one polyester.

3. The process of claim 2, wherein the polyamide is a semi-aromatic polyamide.

4. The process of claim 3, wherein the semi-aromatic polyamide is hexamethylene adipamide/hexamethylene terephthalamide copolyamide and/or hexamethylene terephthalamide/2-methylpentamethylene terephthalamide copolyamide.

5. The process of claim 2, wherein the polyester is one or more of poly(ethylene terephthalate), poly(1,3-propylene terephthalate), poly(1,4-butylene terephthalate), poly(ethylene naphthalate), and poly(1,4-cyclohexyldimethylene terephthalate).

6. The process of claim 1, wherein the reinforcing agent is glass fibers and/or carbon fibers.

7. The process of 1, wherein the thermoplastic polymeric composition comprises about 20 to about 60 weight percent thermoplastic polymer and about 40 to about 80 weight percent reinforcing agent.

8. The process of claim 1, wherein the thermoplastic polymeric composition has a tensile modulus of at least about 13 GPa.

9. The process of claim 1, wherein the thermoplastic polymeric composition has a notched Charpy impact strength of at least about 40 kJ/m².

10. The process of claim 1, wherein the thermoplastic polymeric film comprises at least one polyester and/or polyamide.

11. The process of claim 10, wherein the thermoplastic polymeric film comprises poly(ethylene terephthalate); hexamethylene adipamide/hexamethylene terephthalamide copolyamide; and/or hexamethylene terephthalamide/2-methylpentamethylene terephthalamide copolyamide.

12. The process of claim 1, wherein the thermoplastic polymeric film comprises at least one nanoclay.

13. The process of claim 12, wherein the nanoclay is sepiolite and/or montmorillonite.

14. The process of claim 1, wherein the thermoplastic polymeric film comprises electroconductive carbon black.

15. The process of claim 1, wherein the thermoplastic polymeric film comprises at least one ion conductive polymer.

16. The process of claim 15, wherein the ion conductive polymer is at least one polyetheresteramide.

17. The process of claim 1, wherein the thermoplastic polymeric film comprises at least one layer comprising ethylene/vinyl alcohol copolymers, ethylene/vinyl acetate copolymers, ethylene/vinyl alcohol/vinyl acetate copolymers, and and/or ionomeric polymers.

18. The process of claim 1 wherein the at least one coating comprises a primer surfacer and top coat; a primer surfacer, base coat and clear coat; a base coat and clear coat; and a primer surfacer substitute layer, base coat and clear coat.

19. The process of claim 1, wherein the coated surface has a Class A surface.

20. A process for coating a substrate comprising a vehicle exterior part assembled from metal parts and at least one polymeric part, with visible metal and plastic surfaces, comprising the successive steps of (1) electrodeposition coating the substrate, removing non-deposited electrodeposition coating agent from the substrate and thermally cross-linking the deposited electrodeposition coating and thereby forming an electrodeposition coating primer on the metal surfaces, and (2) applying and curing at least one coating on the visible surfaces of the substrate, wherein at least some of the polymeric parts making up the visible surfaces of the substrate comprise a composite article, comprising,
(a) a molded part having a surface and comprising a thermoplastic polymeric composition comprising at least one thermoplastic polymer and at least one reinforcing agent, and
(b) a thermoplastic polymeric film having first and second surfaces opposite to each other,
wherein the surface of the first component (a) is adhered to the first surface of the film (b) and wherein the second surface of film (b) forms a part of all of the visible polymeric surfaces; and wherein the thermoplastic polymeric composition has a tensile modulus of least about 11 GPa, as measured by ISO method 527-2:1993 at a rate of 5 mm/min on test specimens having a thickness of 4 mm; and a notched Charpy impact strength of at least about 35 kJ/m², as measured by ISO method 179-1:2000.

21. The process of claim 20, wherein the coated surface has a Class A surface.

22. A vehicle exterior part coated by the process of claim 1 or claim 20.
